(19) United States
(12) Patent Application Publication
(10) Pub. No.: US 2014/0015967 A1
(43) Pub. Date: Jan. 16, 2014

(54) SOCIAL INTELLIGENCE, TRACKING AND MONITORING SYSTEM AND METHODS

(71) Applicants: Shaun Moore, Dallas, TX (US); Nezare Chafni, Casablanca (MA)

(72) Inventors: Shaun Moore, Dallas, TX (US); Nezare Chafni, Casablanca (MA)

(21) Appl. No.: 13/837,117

(22) Filed: Mar. 15, 2013

Related U.S. Application Data
(60) Provisional application No. 61/671,904, filed on Jul. 16, 2012.

(51) Int. Cl. H04N 5/232

(52) U.S. Cl. CPC H04N 5/23219
USPC 348/143

(57) ABSTRACT

A social intelligence, tracking and monitoring system includes a data processor, a Wi-Fi module to transmit and receive information over the internet, a camera, and a proximity detector for sensing the presence of a visitor, the proximity detector in communication with the data processor to actuate the camera to take a photographic image of the visitor. Photographic images of persons of interest are downloaded from a social networking site. The facial features in the downloaded photographic images are compared to the facial features in the photographic image taken by the camera to determine if the visitor is recognized. Upon recognition of the visitor by the system, a prerecorded message is played to the recognized visitor. Another prerecorded message is played inviting the visitor to leave a message. An infrared illuminator illuminates the visitor when the data processor determines that the ambient lighting is insufficient. Other applications for the system include doorbell usage types, tracking usage types, shop usage types, and monitoring usage types.

### CROSS-REFERENCE TO RELATED PATENT APPLICATION

This non-provisional patent application claims the benefit of U.S. provisional patent application Ser. No. 61/671,904 filed on Jul. 16, 2012.

### FIELD OF THE DISCLOSURE

The present disclosure relates generally to methods and apparatus for a social intelligence, tracking and monitoring system and, more particularly, to an internet-based, remotely-accessible social intelligence, tracking and monitoring system with facial recognition capability which utilizes internet social network sites to provide information to a facial database.

### SUMMARY OF THE DISCLOSURE

A social intelligence, tracking and monitoring system includes a data processor, a Wi-Fi module in communication with the data processor to transmit information from the data processor to the internet and to send information received from the internet to the data processor, a camera controlled by the data processor for taking photographic images of visitors, and a proximity detector for sensing the presence of a visitor, the proximity detector in communication with the data processor to actuate the camera to take a photographic image of the visitor when detection occurs, the data processor downloads photographic images of persons of interest from a social networking site and then compares the facial features in the downloaded photographic images to the facial features in the photographic image taken by the camera to determine if the visitor is recognized.

Upon recognition of the visitor by the system, the data processor causes a speaker in communication with the data processor to play a prerecorded message to the recognized visitor. The data processor also causes a prerecorded message to be played via the speaker inviting the visitor to leave a message, and a microphone in communication with the data processor transmits the message of the visitor to the data processor.

An infrared illuminator, controlled by the data processor, illuminates the visitor when the data processor determines that the ambient lighting conditions are too dark to obtain an adequate photographic image with the camera. The system is normally in a sleep mode to conserve electrical power and the security system wakes up upon receiving a detection signal from the proximity detector at the data processor. The system may also be actuated by a doorbell button, which is in communication with the data processor. When the doorbell is pressed, the data processor actuates the camera to take a photographic image of a visitor. Photographic images of expected visitors are downloaded from social network sites including one or more of www.facebook.com, www.twitter.com, www.linkedin.com. Other social network sites may also be used if desired.

Methods of using facial recognition to recognize a visitor with a social intelligence, tracking and monitoring system are also included. One such method includes the steps of enabling the data processor to transmit information from the data processor to the internet with a Wi-Fi module and to send information received from the internet to the data processor, taking photographic images of visitors with a camera controlled by the data processor for, sensing the presence of a visitor with a proximity detector, the proximity detector in communication with the data processor to actuate the camera to take a photographic image of the visitor when detection occurs, downloading photographic images of persons of interest from a social networking site with the data processor, and comparing the facial features in the downloaded photographic images to the facial features in the photographic image taken by the camera to determine if the visitor is recognized.

Additional methods include the steps of playing a prerecorded message via a speaker which is in communication with the data processor upon recognition of the visitor. Playing a prerecorded message sent from the data processor to the speaker, the message inviting the visitor to leave a message, receiving the visitor's message at a microphone and transmitting the message of the visitor to the data processor.

Other methods include illuminating the visitor with an infrared illuminator when the data processor determines that the ambient lighting conditions are too dark to obtain an adequate photographic image with the camera. Normally keeping the security system in a sleep mode to conserve electrical power; and waking up the security system upon receiving a detection signal from the proximity detector at the data processor. Providing a doorbell button in communication with the data processor; and actuating the camera to take a photographic image when the doorbell is depressed. Downloading photographic images of expected visitors from social network sites including one or more of www.facebook.com, www.twitter.com, www.linkedin.com.

The social intelligence, tracking and monitoring system may operates as a security system, as a shop usage type system to generate data on customer visits to a business, as a tracking usage type to track the time and attendance of employees, and/or as a monitoring usage type to view logs of data created by the system.

A web application for a social intelligence, tracking and monitoring system controls the settings and operation of the social intelligence, tracking and monitoring system, and the web application provides a plurality of usage types which include a security system usage type, a doorbell usage type, a shop usage type, a tracking usage type, and a monitoring usage type.

### BRIEF DESCRIPTION OF THE DRAWINGS

The present disclosure may best be understood by reference to the following description taken in conjunction with the accompanying drawings, in which like reference numerals identify like elements in the figures, and in which:

FIG. 1 is a block diagram of a social intelligence, tracking and monitoring system with both button activation and motion-detection activation of the system;

FIG. 2. illustrates the steps or methods employed by the social intelligence, tracking and monitoring system of FIG. 1, including various system inputs and outputs;

FIG. 3 is a flow chart showing in greater detail the steps performed by a motion-activated social intelligence, tracking and monitoring system, including the operation of a geo-location function;

FIG. 4 is a flow chart showing in greater detail the steps performed by a button activated social intelligence, tracking and monitoring system;

FIG. 5 is a flow chart showing in greater detail the steps performed by a social intelligence, tracking and monitoring system when tracking usage type;

FIG. 6 is a flow chart showing in greater detail the steps performed by a social intelligence, tracking and monitoring system when monitoring shop usage type; and

FIG. 7 is a flow chart showing in greater detail the settings and functions available to a user in a web application for a social intelligence, tracking and monitoring system.

### DETAILED DESCRIPTION

A detailed description of a security system in accordance with the present disclosure is set forth below. It should be understood that the description below is intended to be exemplary and not exhaustive of all possible variations or applications. Thus, the scope of the disclosure is not intended to be limiting and should be understood to encompass variations or embodiments that would occur to persons of ordinary skill.

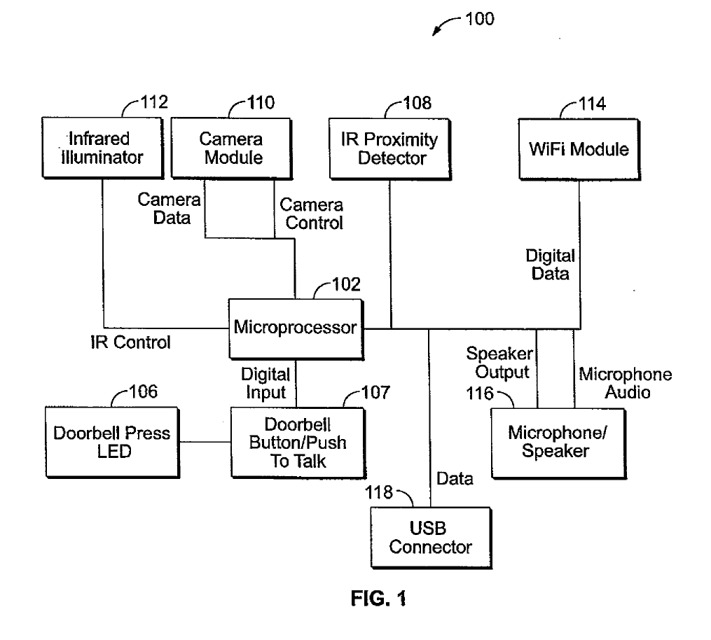

With reference to FIG. 1, a social intelligence, tracking and monitoring system, generally designated 100, is illustrated in block diagram format. System 100 includes a data processor, such as a microprocessor 102. Other types of data processors may alternately be employed, such as a microcontroller, or various forms of computers.

System 100 may be battery powered or obtain electrical power from another source of energy. In either instance, system 100 is typically dormant or at sleep until activated by pressing a switch, such as a doorbell switch 106, or by sensing the presence or proximity of a visitor by means of a sensor, such as an infrared (IR) proximity detector 108. Preferably, doorbell 106 is illuminated, such as by an internal light emitting diode (LED), As indicated at block 107, doorbell 106 may initiate a push-to-talk function in the system.

As the system 100 is powered on, the system initializes the microprocessor 102 and may immediately put the system to sleep to preserve power and/or battery life.

When system 100 is activated, either by a proximity detector 108 or by the doorbell 106, the microprocessor 102 wakes up and determines the level of ambient light, such as by determining the amount of ambient light available at a camera module 110. If the ambient light level is too low for the camera 110, an infrared (IR) illuminator 112 is actuated to provide a sufficient light level for the camera. Camera 110 is then activated and takes a photographic image. If the ambient light level is sufficient and IR illumination is not needed, the microprocessor may proceed to actuate the camera to capture the photographic image immediately.

After the photographic image is taken, the system determines whether the IR illuminator is on. If yes, the system then switches off the IR illuminator. The system 100 then proceeds to send an alert via a Wi-Fi module 114 to a web application. Wi-Fi is a known standard for wirelessly transmitting data over a computer network. Wi-Fi module 114 transmits a signal to a Wi-Fi receiving device, such as to a local area network (LAN) or to a router for transmission of information from system 100 over the internet. A personal computer, laptop computer, tablet, pad, smartphone, or the like, may then receive information from system 100 such that the user or owner of system 100 may observe or hear the alert. If desired, a conventional doorbell alarm (not shown) may also be activated by system 100.

The web application also uses facial recognition technology to cross-reference or compare the photographic image taken by camera module 110 against photographic information available at the user's selected social networks, or against any uploaded pictures and prior tags, to determine the identity of the visitor. If a pre-recorded greeting is available to play, the greeting may be sent to a microphone/speaker module 116. The system 100 may then go back to sleep. If no greeting is available, the system immediately returns to sleep.

The system may also be triggered by sensing a low system voltage, It then wakes up the system and sends a voltage alert to the user via the web application and Wi-Fi module 114.

A connector 118, such as the USB type, may be used to connect system 100 to a computer such that the owner can setup his or her account for the system on a web application.

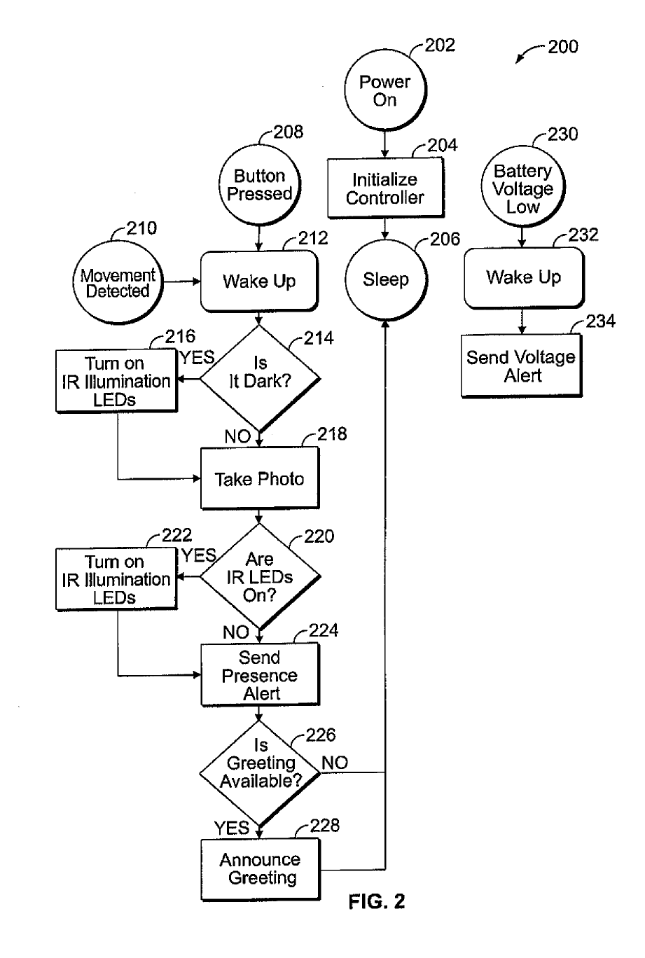

With reference to FIG. 2, there is shown a flow chart 200 illustrating the steps or methods which the microprocessor 102 performs in controlling the system 100 and its response to various system inputs and outputs. As described above, when initially powered on (block 202), the system is initialized (block 204) and the system goes to its default sleep mode (block 206).

If doorbell 106 is pressed (block 208) or if proximity detector 108 senses the presence or movement of a visitor (block 210), microprocessor 102 awakens from its sleep mode (block 212). Doorbell 106 may also function as a push-to-talk switch such that system 100 may operate as an intercom system. When the doorbell is pressed by the visitor, the visitor will have his face scanned by camera 110 and the facial scan information is sent to the microprocessor.

The IR proximity detector 108 may also detect the distance of the visitor from the detector. Microprocessor 102 then determines the ambient light level at block 214. If the ambient light level is too low, the IR illuminator is activated at block 216 such that a suitable image of the face of the visitor may be obtained despite the dark ambient lighting conditions. After illumination or if the ambient light level is sufficient, the process proceeds to block 218 to take a photographic image with camera module 110. The camera module communicates the photographic data through the microprocessor and stores the information on the web application.

After the photographic image has been taken, microprocessor 102 determines if the IR illuminator 112 is on at block 220. If so, the illuminator is turned off at block 222. The process then proceeds to block 224 to send an alert that a visitor is present. At block 224, microprocessor 102 determines if a greeting is available. If so, the greeting is announced at block 228 via the microphone/speaker module 116. The visitor may then hear a pre-recorded message and also allows the visitor to leave a voice message for the user/owner of the system 100.

If the battery voltage is too low (block 230), the microprocessor 102 wakes up (block 232) and sends a voltage alert (block 234).

Various types of metrics are available to a user when accessing the system through the internet. The screen available to the user will allow the user to view information and metrics, such as images, visitor names, time stamps and, possibly, messages left by visitors. It also allows the user to tag an unrecognized face for future use. If the site is accessed through a mobile application, the user may additionally receive push notifications. The user can also access the system and edit his settings using a smartphone application, through which the user can also receive push notifications.

The system utilizes a facial recognition system for automatically identifying or verifying a person from a digital image or a video frame from a video source. Facial recognition software is generally available through a couple of open source libraries, OpenCV, being one such source.

Typically, facial recognition is accomplished by comparing selected facial features from the image to those in a facial database. The facial recognition technology should be able to identify a visitor in bad weather, if they are wearing a hat, have facial hair, etc. In accordance with the present disclosure, the owner's social network account is used for the facial database.

Through the user screen, the user may add, remove, and/or edit the settings of the social networks chosen to integrate with the system. The user may also record/upload a voice message and attach it to a specific visitor.

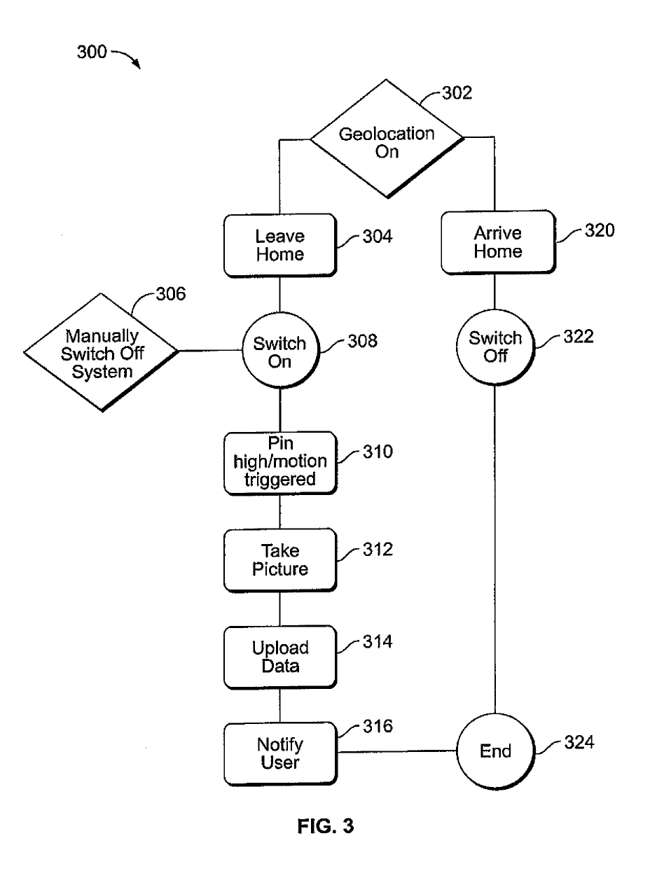

The system also preferably includes a geo-location feature. For example, the system may utilize a mobile application to track the users' whereabouts through the global positioning system (GPS) chips in his/her smartphone. The user may also manually switch the system on and off and switch on and off the notifications feature of the system. As seen in FIG. 3, the geo-location feature is generally turned on (block 302) when the user leaves home (block 304). The system 100 may also be manually switched on at block 306. Preferably, when the user is leaving home, the system is switched on as shown at block 308. If a visitor is sensed, the proximity detector is triggered at block 310 and a picture of the visitor is taken at block 312. The picture data is then uploaded at block 314 and the user is notified of the detection of a visitor and/or the taking of the picture of a visitor at block 316. When the user returns to home at block 320, the geo-location feature may be switched off at block 322, and the system may also be switched off if desired.

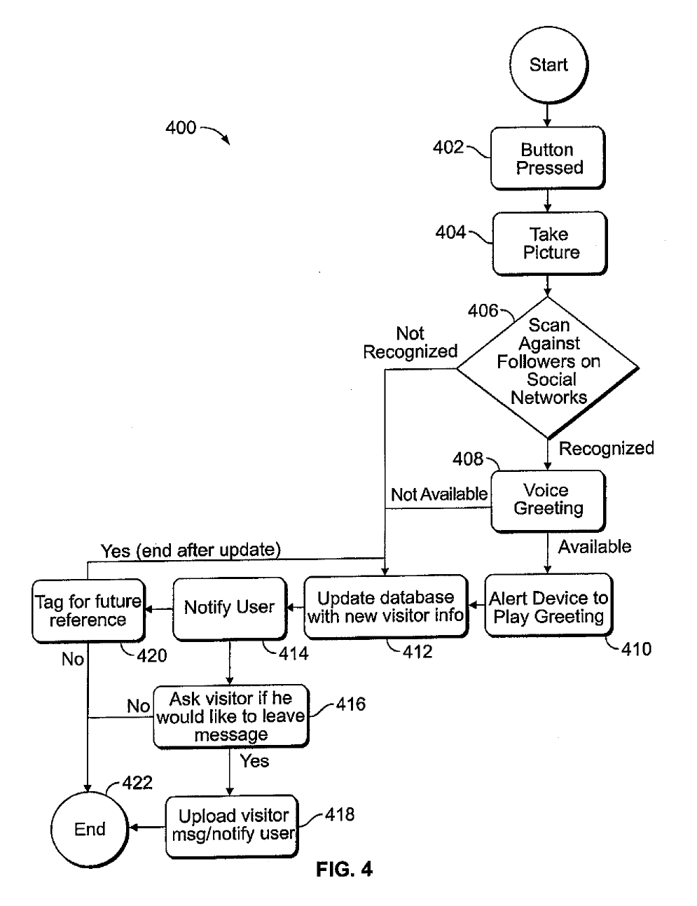

In the flow charts of FIGS. 4, 5 and 6, ovals designate start/end points, diamonds designate decision nodes, parallelograms designate data/input/output, rectangles designate processes, and rounded rectangles designate events.

It can be appreciated that a system may be comprised of two devices, a multi-purpose version equipped with a motion sensor or proximity detector 108 and a version equipped a simple pressable button or doorbell 106 that could replace or compliment the conventional doorbell. Each of the devices can be accessed and controlled from a web application. The “user” is the owner of the device, and the assumption is that the user would install a button version at his front door and a motion sensor version inside his home. However, either could be used without the other. The “visitor” is the person visiting the user, and clicking the button, and/or triggering the motion sensor.

With reference to FIG. 4, a flow chart 400 sets forth in greater detail the steps performed by the button activated method. When button 107 is pressed at block 402, a picture of the visitor is taken at block 404. The picture is then scanned against picture data from the user's various social network accounts (block 406) to determine if any of his/her acquaintances triggered the taking of the picture. If there is a correspondence between the picture data taken by the device and the picture data from the user's social network accounts, the device confirms the recognition of the visitor. The device then determines if a custom message or voice greeting is available at block 408. If so, the custom message is played at block 410. A user can, prior to a visitor arriving, record a custom message and attach it to a specific visitor. For example, if Shaun visits play message 1 and if Mark visits play message 2.

If the visitor was not recognized, or if a voice greeting was not available, or if the device has played a greeting, the database is updated with new visitor information at block 412. The user is then notified at block 414. At block 416, the visitor is asked if he/she would like to leave a message. If so, the visitor's message is uploaded at block 418 and the user is notified of the message. At block 420, notifications may be tagged for future reference.

A visitor has the option of recording a message through the device, which can be instantly forwarded to the user. At block 430, the visitor may be asked if he/she would like to leave a message. If so, at block 432, the visitor records a message at block 434. The user is notified that a message has been recorded at block 436, the recorded message is uploaded at block 438, and this sequence of the process ends at block 440.

At block 422, where the visitor was recognized, if a custom message or greeting was not available (block 442), the user will be asked if he would like to record a message for this visitor for future use (block 444). If so (block 446), the user is directed to a web application for recording the message and the new message may be tagged at block 450 so that the new message will be associated with a particular individual. However, if the user elected not to record a new message at block 444, the process proceeds to block 452 and then ends at block 454.

If the prior attempt to recognize the visitor at block 420 is unsuccessful, the device concludes that the visitor is not recognized at block 456. The user is notified at block 424 and the visitor is asked if he/she would like to leave a message at block 430. A visitor has the option of recording a message through the device, which can be instantly forwarded to the user. If the visitor elects to leave a message, the message process continues as previously explained when the visitor was recognized.

When the visitor is not recognized at block 456, the user may also be asked to tag for future reference at block 450.

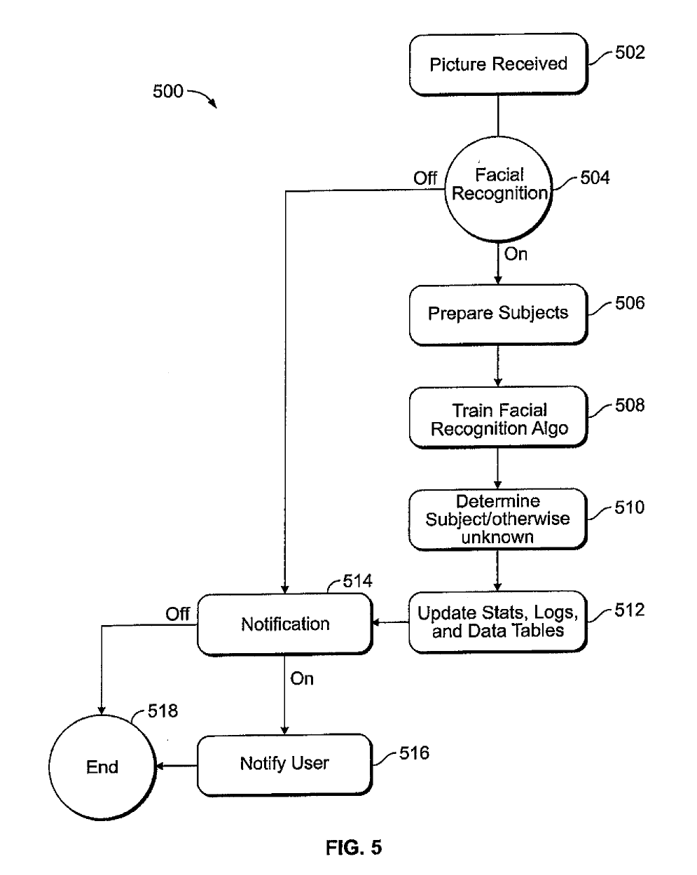

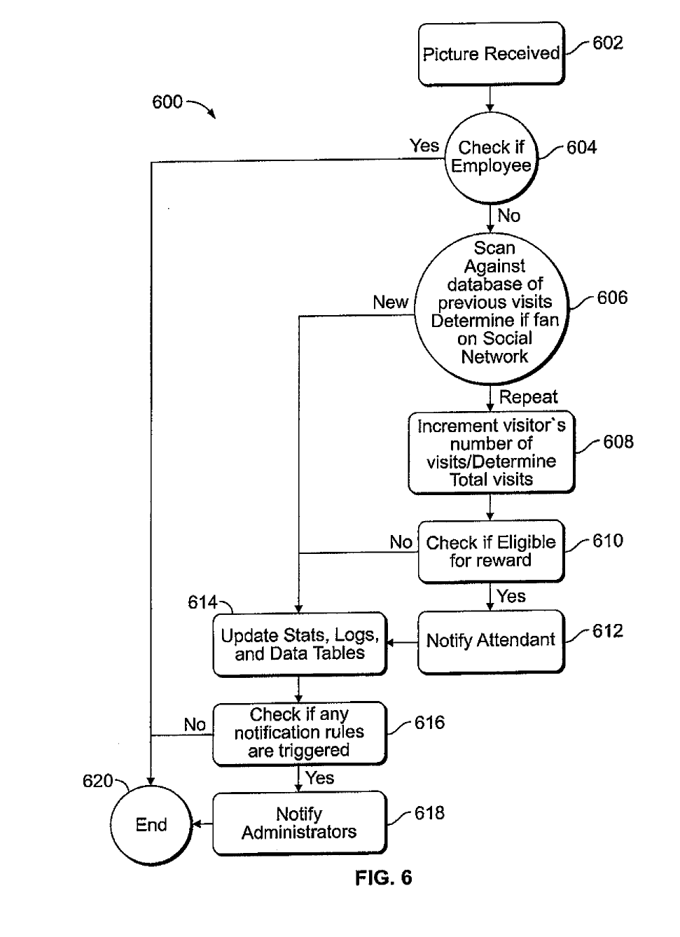

It will be appreciated that the flow chart, generally designated 500, in FIG. 5 for the button actuated device includes features and operates substantially the same shown in the flow chart 400 in FIG. 4 for the motion sensing device. Thus, the reference numerals used in FIG. 5 correspond to similar or related functions in FIG. 4. The main difference is that the device of FIG. 4 is triggered by motion (block 414) occurring in the vicinity of the detector. This makes it ideal for monitoring illegal access to the user's property and belongings. For example, it could be placed within a safe, or otherwise inside the house, effectively monitoring and notifying the user in the event of any illegal access, as well as sending the user a picture of the perpetrator immediately upon detection of motion. The motion sensor possesses all of the features of the button device, meaning that it can also be used as a smart doorbell system, notifying you each time something comes near the door.

FIG. 5 illustrates a flow chart 500 showing in greater detail the steps performed by a social intelligence, tracking and monitoring system when tracking usage type. For example, the system may monitor the time and attendance of employees including the number of times that the employee was late or left early. When picture data is received at block 502, the picture data is subjected to facial recognition at bubble 504. If the facial recognition is off, a notification is sent at block 514. Otherwise, subjects are prepared at block 506, a facial recognition algorithm is trained at block 508 and the subject is determined or otherwise unknown at block 510. At block 512, the statistics, logs and data tables are updated. A notification of the update occurs at block 514, the user is notified at block 516, and the process ends at bubble 518.

FIG. 6 illustrates a flow chart 600 showing in greater detail the steps performed by a social intelligence, tracking and monitoring system when monitoring shop usage type. For example, the system may monitor the number of visits by known customers to a retail establishment, to a grocery store, or to other types of businesses. Different levels of loyalty can be determined if desired. When picture data is received at block 602, it is determined if the person of interest is an employee rather than a customer at block 604. At block 606, a scan is made against a database of previous visits by the person of interest and it may be determined if the person of interest is a fan of the business on a social network. At block 608, the number of visits by the person of interest is updated and the total number of visits is determined. At block 610, a determination is made concerning whether the person is eligible or qualifies for a reward. If so, an attendant is notified at block 612. If a person is new at block 606, or if the person is not eligible for a reward at block 610, or when an attendant has been notified at block 612, the statistics, logs and data tables are updated at block 614. A check is then made to determine if any notification rules were triggered at block 616. If so, an administrator is notified at block 618. Otherwise, the process ends at bubble 620.

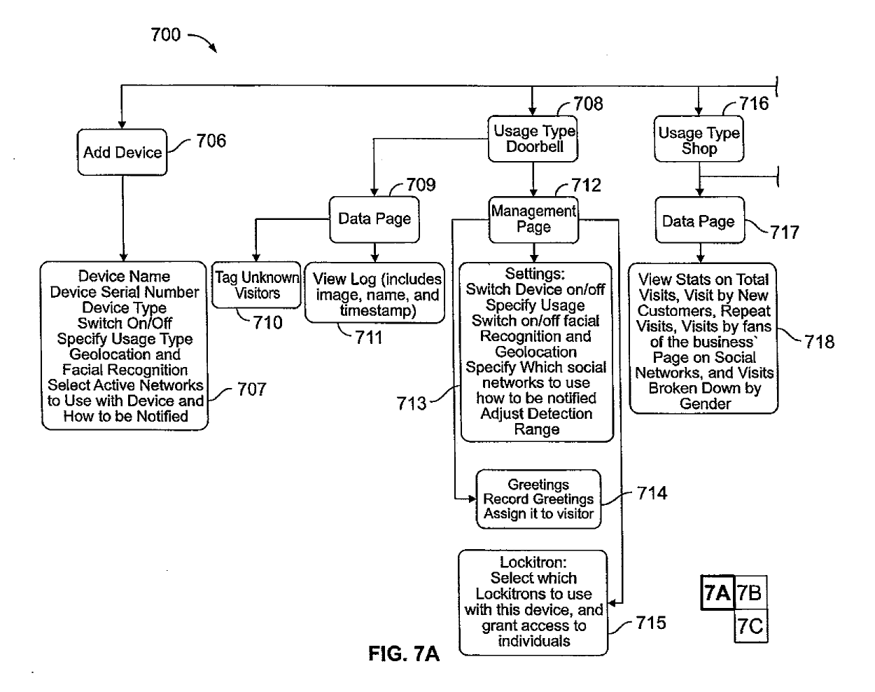

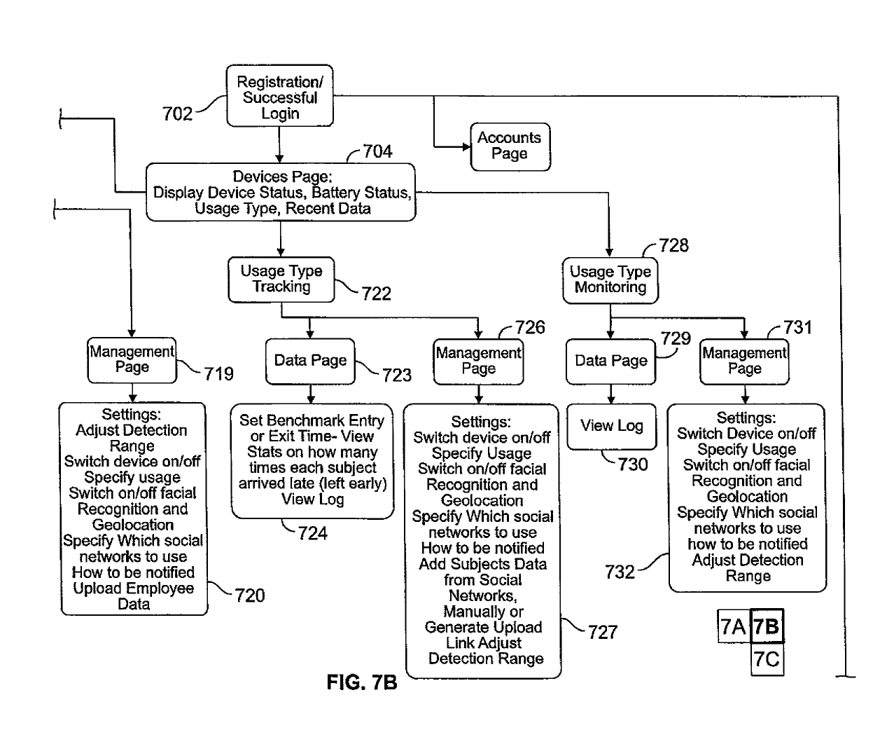

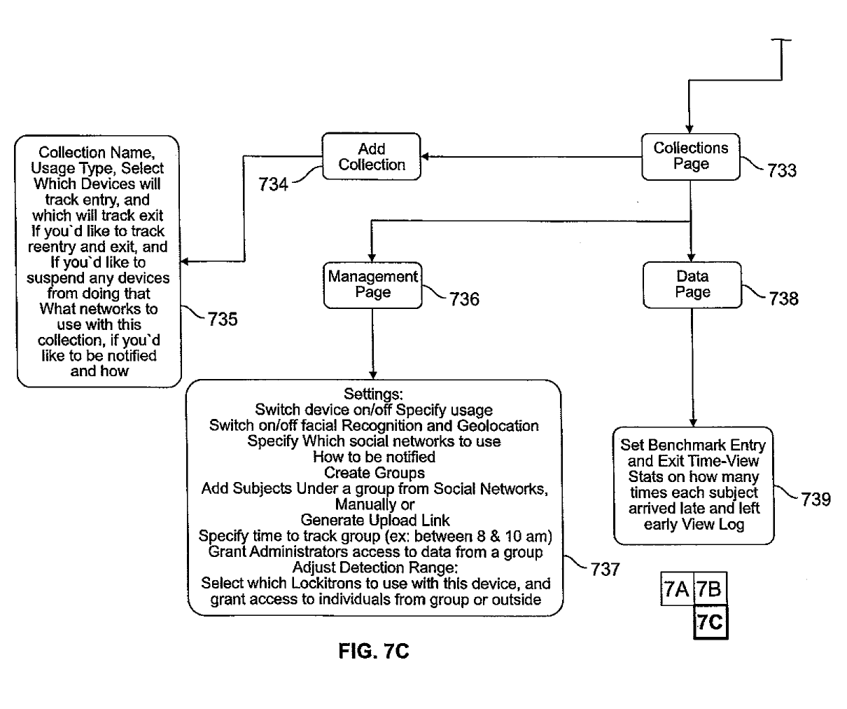

FIG. 7 is a flow chart 700 showing in greater detail the settings and functions available to a user in a web application for a social intelligence, tracking and monitoring system. Upon registration and log in at block 702, the user can go to a devices page (block 704) where device status, battery status, usage type and recent data are displayed. At the add a device, block 706. the device name, serial number and type are specified, geo-location and facial recognition may be turned on and off, active networks may be selected, and the manner of notification may be selected.

At the doorbell usage type blocks 708-715, unknown visitors may be tagged, the device may be switched on and off, facial recognition and geo-location may be switched on and off, social networks may be specified, detection range may be adjusted, greetings may be recorded and associated with a particular visitor, and Lockitron access may be granted to certain individuals.

Lockitron allows the user to give specific visitors or employees access to the user's home or to a controlled work area. The user can select among his/her friends on Facebook, followers and connections on Twitter and LinkedIn, or amongst invited Lockitron users. You can also input a person's name manually and upload his/her photo to give them access. Visits may also be broken down by gender.

At the shop type usage blocks 716-720, stats on total visits, visits by new customers, repeat visits and visits by fans of the business on social networks may be viewed. Settings may be adjusted including adjusting the range detection, social networks to be used may be specified, and employee data may be uploaded.

At the tracking usage type blocks 722-729, entry and exit times for employees may be set, stats on the number of times that a person arrived late or left early may be viewed, and data from social networks may be uploaded.

At the monitoring usage type blocks 728-732, logs may be viewed. At the collections page, blocks 733-739, collections may be named, usage types specified, selection of devices to track entry and exit, groups may be created, subjects may be added under a group form social network sites, and logs may be viewed. Collections deals with those situations where a mass of employees or students enters though a doorway. The faces of some persons may be concealed behind others. Collections aggregates data from a series of social intelligence, tracking and monitoring systems and presents it to the user in a table format. For these situations, a plurality of systems may be placed at different angles to track the mass entry. The systems will work together to track entry and exit. For example the user can specify that systems 1, 2 and 3 track entry and specify that system 4, which may be facing the exit, track early exit.

Thus, a social intelligence, tracking and monitoring system using facial recognition and using picture data from the social network database has been disclosed. The description provided above is intended for illustrative purposes only and is not intended to limit the scope of the disclosure to any particular embodiment or method described herein. For example, various of the steps illustrated in the flow charts may be eliminated and/or steps not illustrated in the flow charts added without departing from the scope of the concepts disclosed herein. Also, while the systems and methods have been described in the context of premises security systems, they could also be used for, by way of example, monitoring classroom attendance and employee check-in.

1. A social intelligence, tracking and monitoring system comprising:
a data processor;
a Wi-Fi module in communication with the data processor to transmit information from the data processor to the internet and to send information received from the internet to the data processor;
a camera controlled by the data processor for taking photographic images of visitors; and
a proximity detector for sensing the presence of a visitor, the proximity detector in communication with the data processor to actuate the camera to take a photographic image of the visitor when detection occurs;
the data processor downloading photographic images of persons of interest from a social networking site and then comparing the facial features in the downloaded photographic images to the facial features in the photographic image taken by the camera to determine if the visitor is recognized.

2. The social intelligence, tracking and monitoring system of claim 1 further comprising:
a speaker in communication with the data processor, the data processor causing a prerecorded message to be played via the speaker to a recognized visitor.

3. The social intelligence, tracking and monitoring system of claim 2 further comprising:
a microphone in communication with the data processor, the data processor causing a prerecorded message to be played via the speaker inviting the visitor to leave a message, the microphone transmitting the message of the visitor to the data processor.

4. The social intelligence, tracking and monitoring system of claim 1 further comprising:
an infrared illuminator controlled by the data processor for illuminating the visitor when the data processor determines that the ambient lighting conditions are too dark to obtain an adequate photographic image with the camera.

5. The social intelligence, tracking and monitoring system of claim 1 wherein the system is normally in a sleep mode to conserve electrical power and the system wakes up upon receiving a detection signal from the proximity detector at the data processor.

6. The social intelligence, tracking and monitoring system of claim 1 further comprising:
a doorbell button in communication with the data processor whereby the data processor actuates the camera to take a photographic image when the doorbell is depressed.

7. The social intelligence, tracking and monitoring system of claim 1 wherein the social network sites from which photographic images of expected visitors are downloaded includes one or more of www.facebook.com, www.twitter.com, and www.linkedin.com.

8. A method of recognizing a visitor with a social intelligence, tracking and monitoring system having a data processor, the steps of the method comprising:
enabling the data processor to transmit information from the data processor to the internet with a Wi-Fi module and to send information received from the internet to the data processor;
taking photographic images of visitors with a camera controlled by the data processor for;
sensing the presence of a visitor with a proximity detector, the proximity detector in communication with the data processor to actuate the camera to take a photographic image of the visitor when detection occurs;
downloading photographic images of persons of interest from a social networking site with the data processor; and
comparing the facial features in the downloaded photographic images to the facial features in the photographic image taken by the camera to determine if the visitor is recognized.

9. The method of claim 8 further comprising the step of:
upon recognition of the visitor, playing a prerecorded message via a speaker which is in communication with the data processor.

10. The method of claim 8 further comprising the steps of:
playing a prerecorded message sent from the data processor to the speaker, the message inviting the visitor to leave a message,
receiving the visitor's message at a microphone; and
transmitting the message of the visitor to the data processor.

11. The method of claim 8 further comprising the step of:
illuminating the visitor with an infrared illuminator when the data processor determines that the ambient lighting conditions are too dark to obtain an adequate photographic image with the camera.

12. The method of claim 8 further comprising the steps of:
normally keeping the security system in a sleep mode to conserve electrical power; and
waking up the security system upon receiving a detection signal from the proximity detector at the data processor.

13. The method of claim 8 further comprising the step of:
a doorbell button in communication with the data processor; and
actuating the camera to take a photographic image when the doorbell is depressed.

14. The method of claim 8 further comprising the step of:
downloading photographic images of expected visitors from social network sites including one or more of www.facebook.com, www.twitter.com, and www.linkedin.com.

15. The social intelligence, tracking and monitoring system of claim 1 wherein the system operates as a security system.

16. The social intelligence, tracking and monitoring system of claim 1 wherein the system operates as a shop usage type system and generates data on customer visits to a business.

17. The social intelligence, tracking and monitoring system of claim 1 wherein the system operates as a tracking usage type to track the time and attendance of employees.

18. The social intelligence, tracking and monitoring system of claim 1 wherein the system operates as a monitoring usage type to view logs of data created by the system.

19. A web application for a social intelligence, tracking and monitoring system of claim 1, the web application controlling the settings and operation of the social intelligence, tracking and monitoring system, and the web application provides a plurality of usage types.

20. The web application of claim 19 wherein the usage types provided by the web application include a security system usage type, a doorbell usage type, a shop usage type, a tracking usage type, and a monitoring usage type.
